(19) United States
(12) Patent Application Publication
(10) Pub. No.: US 2006/0288956 A1
(43) Pub. Date: Dec. 28, 2006

(54) Pet repellent cord cover

(75) Inventors: Matthew D. Miller, Belgium, WI (US); Thomas M. Luebke, Menomonee Falls, WI (US)

Correspondence Address: QUARLES & BRADY LLP, 411 E. WISCONSIN AVENUE, SUITE 2040, MILWAUKEE, WI, 53202-4497, US

(73) Assignee: Silent Guardian, Inc.

(21) Appl. No.: 11/371,034

(22) Filed: Mar. 8, 2006

Related U.S. Application Data
(60) Provisional application No. 60/694,730, filed on Jun. 28, 2005.

(51) Int. Cl. A01K 37/00

(52) U.S. Cl. 119/712

(57) ABSTRACT

A pet repellent plastic cover is placed over cords to prevent pets from chewing the cords. This cover prevents injury to the pet and damage to the cord.

### CROSS-REFERENCE TO RELATED APPLICATION

This application claims benefit to U.S. Provisional Patent Application No. 60/694,730 filed on Jun. 28, 2005.

### STATEMENT CONCERNING FEDERALLY SPONSORED RESEARCH OR DEVELOPMENT

Not applicable.

### FIELD OF THE INVENTION

This invention relates to a cover for cords. In particular, this invention refers to a cover that contains an animal repellent to protect cords from damage by chewing pets and to protect pets from injury from the cords.

### BACKGROUND OF THE INVENTION

Young pets, especially puppies, kittens and rabbits have a tendency to chew on any available media. This is particularly true during the period between the arrival of their baby teeth and full development of their adult teeth.

This chewing is not limited to chew toys or other appropriate media. Rather, anything within the pet's reach is a potential target. This may include furniture, flooring, walls, woodwork or anything left in an area accessible to the pet.

During this period, the chewing is particularly damaging. The baby teeth are significantly sharper than adult teeth, and the pets feel the need to constantly chew in order to help the teeth completely break through the gum line.

Particularly easy targets for the pets are electrical cords, electrical wires, coaxial television cables, telephone cords, computer cables, fiber optic wires or any other electrical or data carrying wires (hereafter referred to collectively as cords). The size of the cord is perfectly suited to fit within the pet's mouth. The coverings are often made of a rubberized plastic of medium durometer, which is especially appealing to teething pets. The design of the cord proves to be an ideal chewing target. Irreparable harm can be done to the cord or pet with one bite. This can occur well before the owner has a chance to pull the pet away.

This poses a severe problem. The cords are usually expensive to replace if it is possible to replace them. Pulling on these cords by the pets may cause the connected equipment to fall and be damaged or cause injury to the pet or any bystander. The coating may cause harm to the animal due to a physical reaction or an inability to digest. However, the most serious danger is electrical shock. If the animal makes contact with the exposed wires and completes the electrical circuit, the resultant shock could cause burns to the mouth, damage to the nervous system, heart arrhythmia or even death.

Several concepts have been proposed to deter pets from chewing on these cords. The most common method in use is to spray the cord with a commercially available animal repellent made from a bad tasting, non-toxic substance. The main problem with this is that the animal must taste the repellent in order for it to be effective. By default, the animal must already have contacted the cord with its mouth. If the deterrent is not immediately effective, the animal may begin to chew.

Another concept is to cover the cord with a flexible plastic tube. The purpose of this covering is to provide protection to the cord if the animal is chewing. The problem with this concept is that the wires can still be damaged through the cover or after the cover has been damaged. These covers only provide temporary protection and do nothing to deter the chewing.

Another concept is to cover the cord with foil. A common belief is that animals do not like to chew on foil. As evidenced by the objects that pets will chew, this belief is incorrect. If the pet does chew on the foil, it may ingest pieces which may lead to digestive problems. It also proves to be unsightly to have foil-covered cords in plain sight within the pet owner's home.

Another concept is to coat the cord with a glue or paste and then sprinkle it with pepper. This has the same disadvantage as the taste repellent spray in that it requires the pet to contact the cord with its mouth in order to be effective. It also creates a mess on the cord or the cord's surroundings. The glue will collect dirt, or the cord will transfer the glue to surrounding objects.

U.S. Pat. No. 5,985,010 describes dipping the cord in a plastic coating which has been mixed with a refined pepper extract. This is expensive, time consuming, permanent and again requires the pet's mouth to make direct contact with the cord.

U.S. Pat. No. 5,985,010 also describes a conduit made of plastic with a pepper filler. This again has the disadvantage of requiring the animal to make direct contact to the conduit with its mouth. This is also impractical to put into practice in a living environment. Cords typically have connectors on the free end. If the conduit is made small enough to fit tightly over the cords, the connectors will not fit through the conduit. If the conduit is made large enough to allow the connectors to fit, the conduit becomes unsightly and obtrusive.

U.S. Pat. No. 6,395,290 describes a solution to repel raccoons. Methyl nonyl ketone or animal predator urine, known animal repellents, are mixed with a polymer matrix and molded into a sheet, film, shaped article or pellet and applied in an area to repel raccoons and other wild animals from disturbing garbage cans or gardens. This does not provide protection from pets chewing on cords.

U.S. Pat. No. 4,169,898 describes the considerations necessary when using repellents in areas inhabited by humans. These considerations include using repellents that are substantially non-toxic to mammals and using repellents that emit an odor that is not unpleasant to humans. This patent describes methyl nonyl ketone and cinnamaldehyde as being effective animal repellents that meet these considerations. The patent further describes the effectiveness of the mixture of both repellents as being vastly superior to either of its constituent parts alone. The patent also provides for a carrier that may be used to deliver the repellent to the desired area. This patent, however, does not provide for a means of encapsulating exposed cords.

U.S. Pat. No. 4,555,015 describes a method for dispersing the repellent of U.S. Pat. No. 4,169,898 over garbage bags. Plastic garbage bags are placed in a package that is substantially impervious to the repellent. The repellent is added to a comparatively small portion of the bags and the package is sealed. Within a few days, the bags will become pervaded with the repellent over substantially all of their surfaces. This proves to be a convenient method for applying the repellent, but does not address the issue of pets chewing electrical cords.

A solution is needed that will be inexpensive for the pet owner, will be easy to install, will not detract from the appearance of the cord, will not emit an odor that is offensive to humans and will repel pets before they make physical contact with the cover or the cord.

### SUMMARY OF THE INVENTION

This invention provides a pet repellent cover for a cord. In the preferred embodiment, the cover is molded from a plastic that contains an animal repellent such as methyl nonyl ketone or cinnamaldehyde, both of which are repulsive to animals, but are mildly pleasing to humans. The cover is placed over a single cord or multiple cords and continually emits an odor that deters pets from chewing on the cord or cover.

In another embodiment, a taste repellent, such as a bitter agent or pepper extract, is combined with the odoriferous repellent. The taste repellent acts as a second line of defense in the event that the pet is not repelled by the smell.

In the preferred embodiment, the cover is extruded as a continuous length. In one aspect, the pet repellent is mixed with the plastic prior to extrusion. This integrates the chemical into the plastic and provides for a uniform continuous release of the repellent.

In another aspect, the repellent, in liquid form, is added to a bag containing the cover, and the bag is sealed. The repellent will coat the cover and migrate throughout the plastic providing for a uniform dispersion. A carrier may be used to aid in the dispersion.

In another aspect, the repellent is applied in solid form to the surface of the plastic immediately after it leaves the extruder. In this manner, the repellent can be pressed into the hot surface of the plastic and held in place with a mechanical bond. This allows for the repellent to be only at the exterior surface where it will be most effective.

In another aspect, the solid repellent is adhered to the surface of the cover with an adhesive. This allows for less expensive processing than the method of pressing it into the surface.

Through the use of the extrusion method, any length can be supplied. The customer can cut the cover to the desired length, or predetermined lengths can be sold that match cords commonly in use.

In another embodiment, the cover is woven in the form of expandable braided sleeving. The repellent can be included by the above mentioned methods of mixing with, bonding to, or coating the plastic, prior to, or after production of the woven sleeve.

Several methods can be employed to install the cover on the cord. In one aspect, a cut. through one side extends the entire length of the extruded version of the cover. This provides for an opening through which the cord can be inserted. When the cover closes, the cord becomes completely encapsulated and protected by the cover.

In another aspect, a spiral cut extends the entire length of the extruded version of the cover. This cut allows the user to wrap the entire cord. This also allows the cover to expand to encapsulate larger cords or bundles of cords while still providing complete encapsulation.

In the expandable braided sleeving version, no cut is necessary. By design, the sleeve can be expanded to fit over the connector or plug on the ends of the cord. Once in place, the cover will relax whereas the length will increase to cover the entire cord and the diameter will decrease to appropriately encapsulate the body of the cord. Varying or irregular sizes can be enclosed with this design.

The design of the cover can also be customized to individual application. In one embodiment, the internal cross-section of the cover is slightly larger than the external cross-section of a typical cord. This will allow the cover to be minimally obtrusive and will not be noticed by the casual observer.

In another embodiment, the cover can be made larger to encapsulate many cords simultaneously. This provides a distinct advantage in applications such as computers or stereo equipment. In these situations, the user will often tie a group of cords together to make the area look cleaner and to ensure that the cords remain out of the way. A larger cover can be used to bundle these cords while providing the desired protection from pets.

In all of the above embodiments, the cover can be produced in different colors. The colors can be chosen to match the cord, the object to which the cord is connected or the surroundings. It can also be produced in decorative colors to highlight cords or for use as color coding in situations where different cords need to be identified. The cover can also be produced using clear plastic to allow the cords to be seen if desired.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a view of a typical application of a form of the invention on a lamp cord;

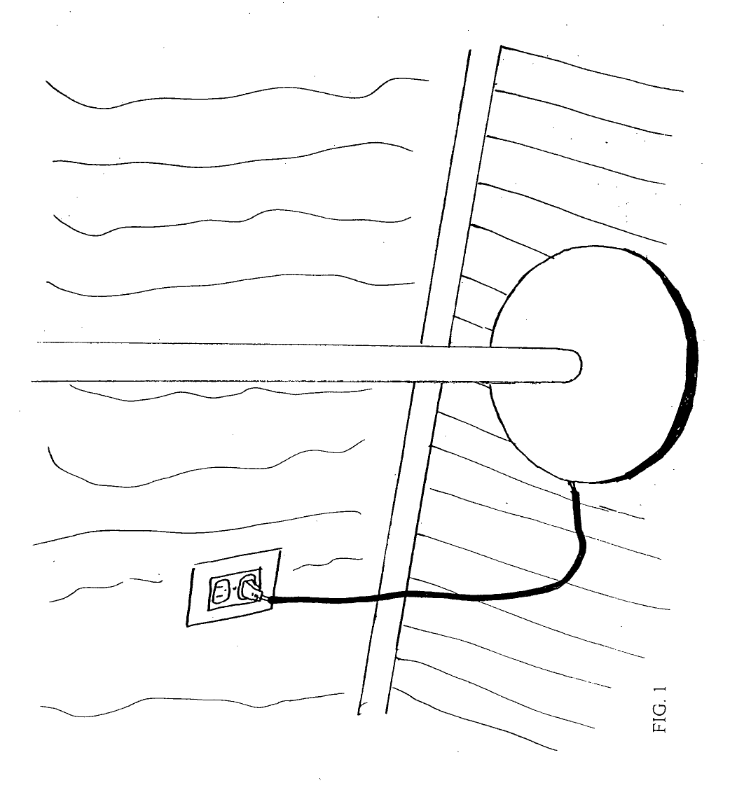

FIG. 2 is a view showing the installation of the cover over a cord via a cut down the length of the cover;

FIG. 3 is a view showing a section of the straight cut cover containing multiple cords;

FIG. 4 is a view showing the installation of the cover over a cord by wrapping the spiral cut cover around the length of the cord;

FIG. 5 is a view showing a section of the spiral cut cover containing multiple cords;

FIG. 6 is a view showing the installation of the expandable braided sleeving version over a cord; and

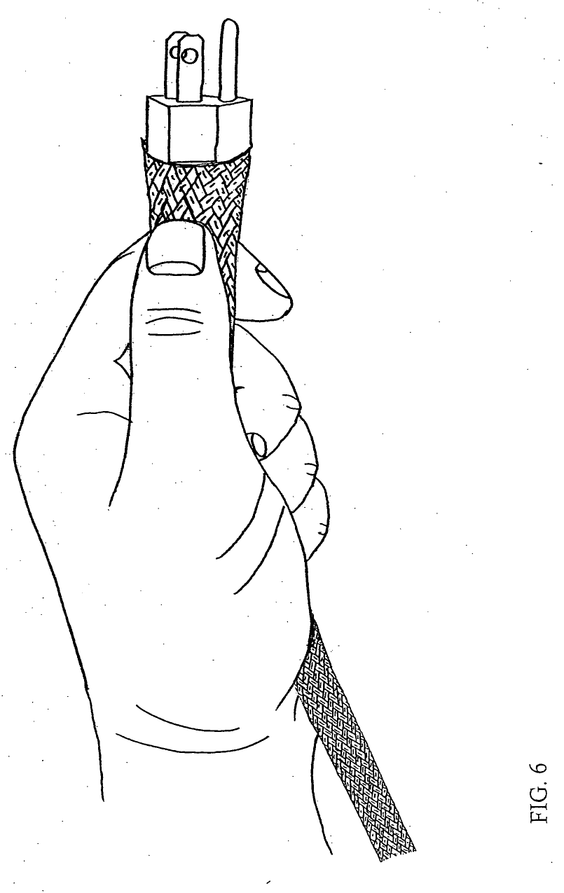

FIG. 7 is a view showing a section of the expandable braided sleeving containing multiple cords.

### DETAILED DESCRIPTION OF THE PREFERRED EMBODIMENT

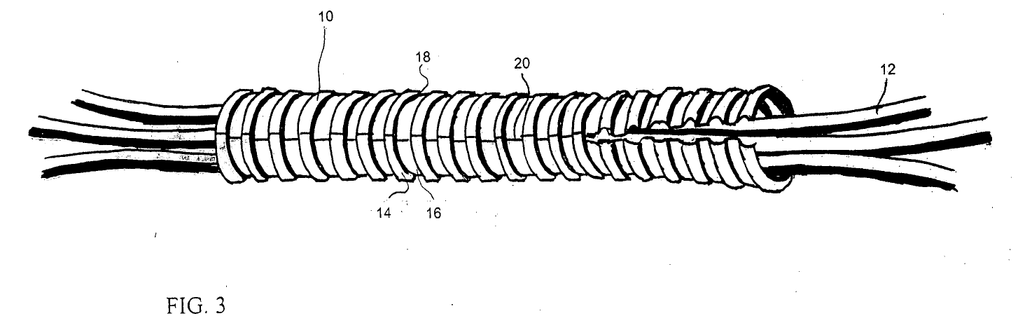

Referring to FIG. 3, a cover 10 of the invention encapsulates multiple cords 12. The cover 10 is formed of a corrugated geometry consisting of a repeating series of peaks of a large diameter 14 joined to valleys of a smaller diameter 16 via radial walls 18. By forming the cover 10 in this manner, the geometry will allow the cover 10 to bend. The cover 10 contains a single cut 20 that extends longitudinally for the entire length of the cover 10. The cover 10 thus is in the known form of a corrugated tube with a longitudinal slit extending for its length, commonly referred to as flex tube or split loom.

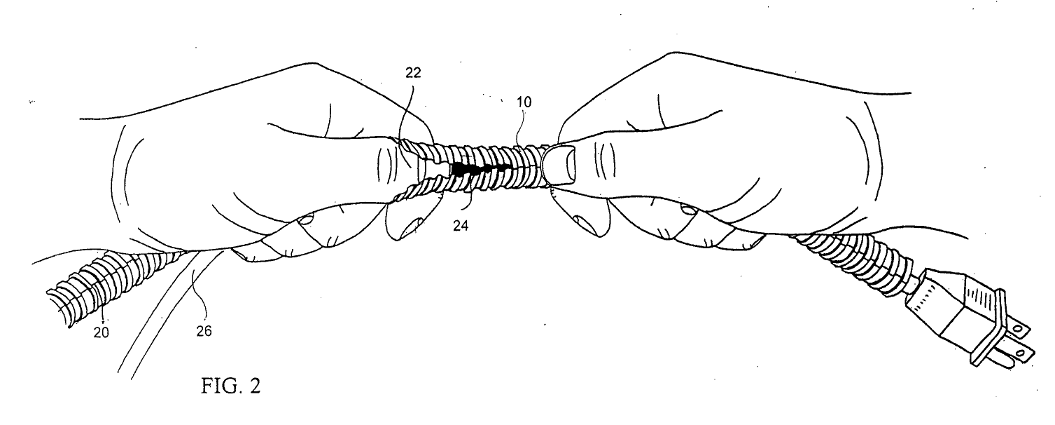

Referring to FIG. 2, the installer can use a thumb 22 to create an opening 24 in the cover 10. A cord 26 can be inserted into the opening 24. As the thumb 22 is slid along the cut 20, the opening 24 will move with the thumb 22, allowing the cord 26 to be progressively inserted into the cover 10. As the thumb 22 is slid along the cut 20, the opening 24 will close behind the thumb 22 as the cover 10 returns to its relaxed geometry. Upon completion of the installation of the cover 10, the cord 26 will be radially encapsulated by the cover 10. In this manner, a single cord (FIG. 2) or multiple cords (FIG. 3) can be encapsulated by the cover 10.

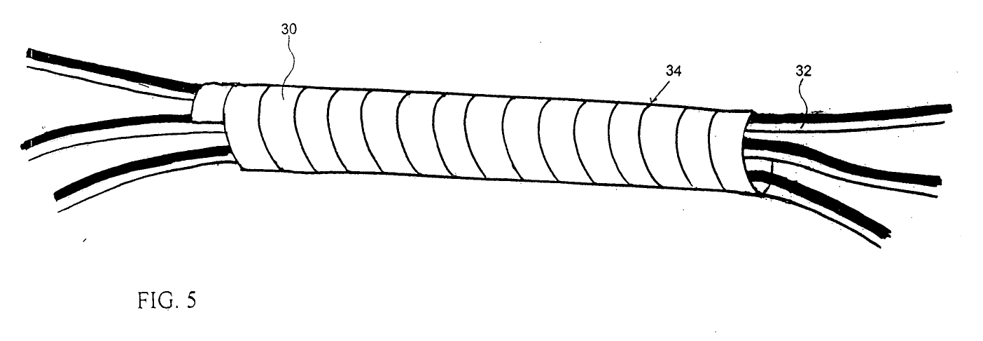

Referring to FIG. 5, a cover 30 of the invention encapsulates multiple cords 32. The cover 30 is formed in the shape of a tube of uniform diameter. The cover 30 contains a cut 34 that extends helically for the entire length of the cover 30. By forming the cover 30 in this manner, the geometry will allow the cover 30 to bend. The geometry will also allow the cover 30 to expand diametrically to encapsulate bundles of cords that are larger than the relaxed diameter of the cover 30. The cover 30 thus is in the known form of a tube with a spiral cut extending for its length, commonly referred to as spiral wrap.

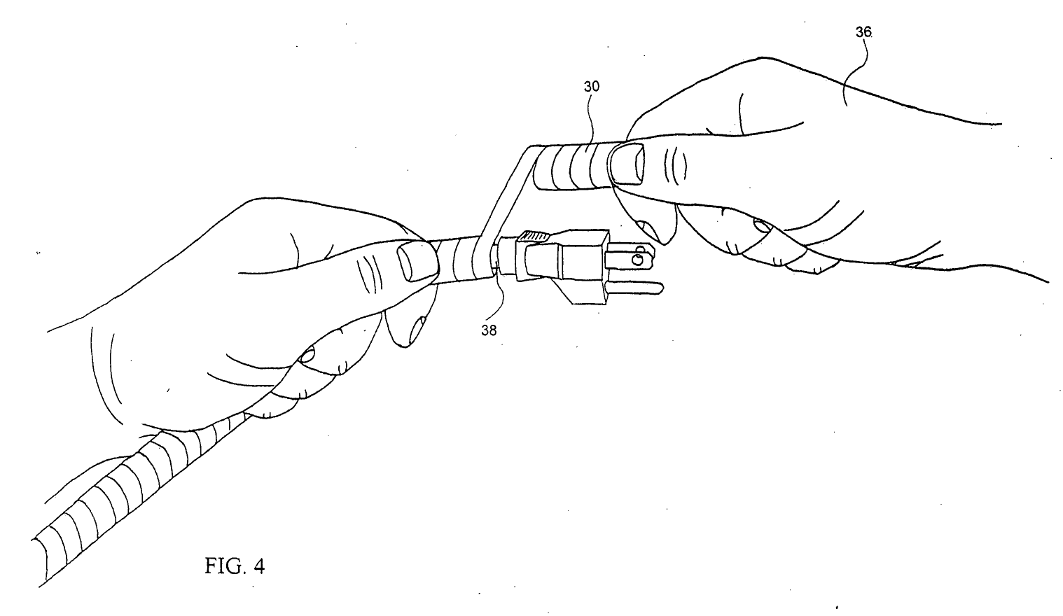

Referring to FIG. 4, the installer can grasp the cover 30 with a hand 36 and wrap the cover 30 around a cord 38. By continually wrapping the cord 38 with the cover 30, the entire length of the cord 38 becomes radially encapsulated by the cover 30. In this manner, a single cord or multiple cords can be encapsulated by the cover 30.

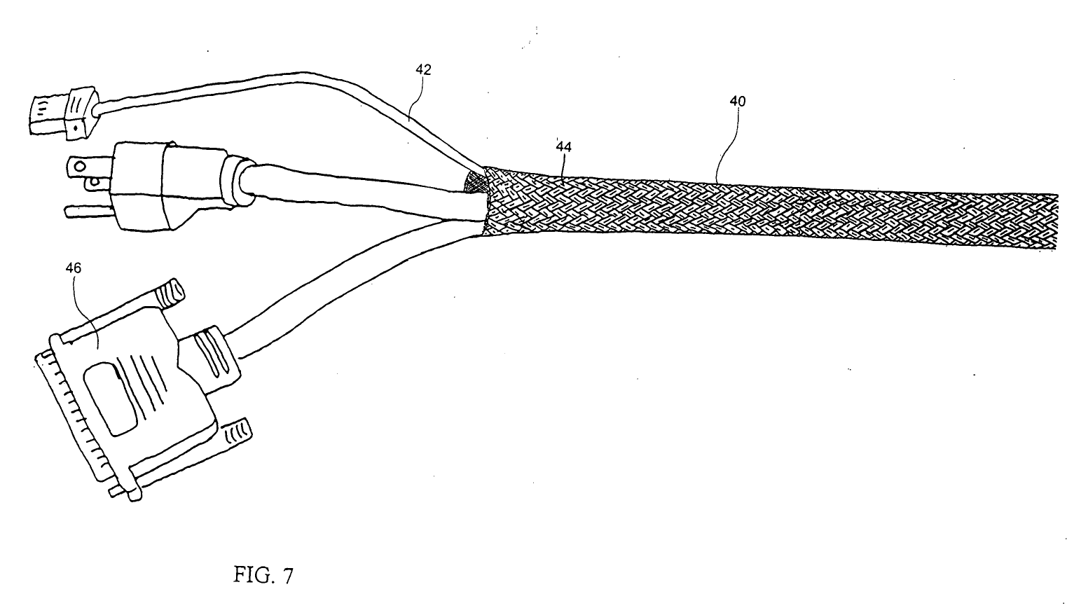

Referring to FIG. 7, a cover 40 of the invention encapsulates multiple cords 42. The cover 40 is formed by weaving multiple fibers 44 of material in the shape of a tube of uniform diameter. The cover 40 thus is in the known form of a tube of woven fibers, commonly referred to as braided sleeving or expandable sleeving. By forming the cover 40 in this manner, the fibers 44 will allow the cover 40 to expand diametrically when compressed axially, allowing the cover 40 to fit over the connectors 46 on the ends of cords 42. This geometry will also allow the cover 40 to bend. In this manner, a single cord or multiple cords can be encapsulated by the cover 40.

In each of the descriptions above, the cover is formed of a composite material consisting of a plastic and an animal repellent. A number of plastics can be used. Polyethylene is a preferred example. It is known to be suited to the production of these types of tubes. The properties allow the tube to be flexible, moldable in many colors and compatible with the preferred repellents. It also acts as a sustained release matrix for the repellent. Other plastics can be used to form the tube.

A number of repellents can be used. Methyl nonyl ketone or cinnamaldehyde are preferred examples. The chemicals are known animal repellents. They emit an odor that is negatively perceptible to animals. Pets will smell the repellent and be inclined to leave the area where the cover is located. They will not chew on the cord or cover or even make physical contact. The odor of each is positively perceptible to humans. Methyl nonyl ketone is commonly used as a mildly pleasing additive scent with a citrus tone. Cinnamaldehyde is commonly used in food products in which a cinnamon smell and taste are desired. Other known repellents can be used alone or in combination with each other or with the above.

Several methods can be used to produce the cover. In all methods, the repellent must be integrated with the plastic. The preferred method of production is extrusion. The repellent can be integrated with the plastic before extrusion by adding both materials to the barrel in the extrusion machine. In this case, the percentage of the repellent can vary. The most common percentage of repellent is 2%. The melted composite is extruded into the required form. The repellent can also be integrated with the plastic after extrusion by adding it to a bag containing the tube. The repellent will migrate throughout the plastic before the consumer purchases the product. The repellent can also be integrated with the plastic by bonding it to the surface of the extruded tube. The bond can be achieved through mechanical means by pressing it into the surface of the tube while the plastic is still warm, or by the use of an adhesive to hold the repellent to the surface.

In the case of integrating the repellent with the plastic before extrusion or adding it to the bag containing the tube after production, the plastic acts as a slow release mechanism. The repellent that has located on the surface will keep pets away immediately after the cover has been placed on the cord. The remaining repellent must migrate through the plastic in order to escape and repel the pets. In this manner, the cover will continually emit repellent in sufficient quantities to keep pets away from the cover. The effectivity will last through the duration of the chewing stage of the pets.

The cover 10 of FIG. 3 can be produce through this method as a continuous tube. The cut 20 can be made along the entire length after the composite has cooled and solidified. In this manner, a cover of any length and diameter can be produced.

The cover 30 of FIG. 5 can be produced through this method as a continuous tube. The cut 34 can be made helically along the entire length after the composite has cooled and solidified. In this manner, a cover of any length and diameter can be produced.

The fibers 44 of cover 40 of FIG. 7 can be produced through this method as continuous strands. After the composite has cooled and solidified, the strands can be woven into the form of a tube of any length and diameter.

A preferred embodiment of a pet repellent cord cover of the invention has been described in considerable detail. Many modifications and variations to the preferred embodiment described will be apparent to a person of ordinary skill in the art. Therefore, the invention should not be limited to the embodiment described.

We claim:

1. A cover for use over at least one cord comprising:
a tube of hollow cross-section and with sufficient internal cross-sectional area to completely encapsulate at least one cord, said tube being installable over said cord without removing the ends of the cord; and
an animal repellent that is negatively perceptible to a pet, wherein said repellent is integrated with the tube.

2. A cover as claimed in claim 1 wherein said cover is flexible.

3. A cover as claimed in claim 1 wherein said cover is molded from a plastic.

4. A cover as claimed in claim 3 wherein animal repellent is mixed with the plastic prior to molding, and said mixture is formed into the desired shape.

5. A cover as claimed in claim 4 wherein said animal repellent is positively perceptible to the olfactory sense of humans.

6. A cover as claimed in claim 4 wherein said cover incorporates an axial cut along the entire length to allow the cover to be placed over a single cord or multiple cords.

7. A cover as claimed in claim 4 wherein said cover incorporates a helical cut along the entire length to allow the cover to be wrapped around a single cord or multiple cords.

8. A cover as claimed in claim 4 wherein said cover is formed by braiding multiple continuous fibers of the repellent plastic into a tubular form.

9. A cover as claimed in claim 8 wherein said cover has a braided geometry that allows the internal cross-sectional area to change;
wherein said area can increase to allow passage of cord plugs and connectors, and said area can decrease upon passage to conform to the diameter of a single cord or the diameters of multiple cords.

10. A cover as claimed in claim 3 wherein animal repellent is integrated with the plastic tube after the plastic is formed into the desired tube shape.

11. A cover as claimed in claim 10 wherein said animal repellent is positively perceptible to the olfactory sense of humans.

12. A cover as claimed in claim 10 wherein said cover incorporates an axial cut along the entire length to allow the cover to be placed over a single cord or multiple cords.

13. A cover as claimed in claim 10 wherein said cover incorporates a helical cut along the entire length to allow the cover to be wrapped around a single cord or multiple cords.

14. A cover as claimed in claim 10 wherein said cover is formed by braiding multiple continuous fibers of the plastic into a tubular form.

15. A cover as claimed in claim 14 wherein said cover has a braided geometry that allows the internal cross-sectional area to change;
wherein said area can increase to allow passage of cord plugs and connectors, and said area can decrease upon passage to form around the diameter of a single cord or diameters of multiple cords.
